(19) United States
(12) Patent Application Publication
(10) Pub. No.: US 2026/0264701 A1
(43) Pub. Date: Sep. 10, 2026

(54) DANGER DETECTION SYSTEM, DANGER DETECTION METHOD, AND RECORDING MEDIUM

(71) Applicant: NEC Corporation, Mirato-ku, Tokyo (JP)

(72) Inventor: Mari OOTA

(73) Assignee: NEC Corporation, Mirato-ku, Tokyo (JP)

(21) Appl. No.: 19/121,484

(22) PCT Filed: Nov. 18, 2022
(86) PCT No.: PCT/JP2022/042807

§ 371 Date: Apr. 16, 2025

(51) Int. Cl. B60W 50/00; B60R 25/25; B60R 25/31; B60W 40/08; G06V 20/59; G06V 40/16

(52) U.S. Cl. CPC B60W 50/0098; B60R 25/25; B60R 25/31; B60W 40/08; G06V 20/597; G06V 40/172; B60W 2040/0881; B60W 2420/403; B60W 2556/45

(57) ABSTRACT

A danger detection system comprising:
at least one memory storing instructions; and
at least one processor configured to execute the instructions to:
determine whether an inside of a parked or stopped vehicle is in a dangerous state based on at least one of information of an environment on the inside of the vehicle and information of an environment on an outside of the vehicle;
detect a person in the vehicle from a video of the inside of the vehicle, the video being determined that the vehicle is in the dangerous state; and
perform, based on a result of detection of the person in the vehicle, at least one of notification to the outside of the vehicle, unlocking of a door of the vehicle by an operation of an authorized person with respect to the vehicle, and opening of a window of the vehicle by the operation of the authorized person.

### TECHNICAL FIELD

The present disclosure relates to a danger detection system and the like in a vehicle.

### BACKGROUND ART

For example, a vulnerable person such as a child may be left in the vehicle, and an accident such as heat stroke may occur.

For example, PTL 1 describes detecting the presence or absence of a living body in a vehicle in a case where an in-vehicle temperature is equal to or higher than a reference value, and issuing a warning in a case where the living body is present in the vehicle. For example, PTL 2 describes that whether an environment in a vehicle is in a dangerous state for a living body left behind is determined based on a temperature in the vehicle and an amount of carbon monoxide in the atmosphere in the vehicle, and a warning alarm for warning that a predetermined time has elapsed since the living body has been left in the vehicle is performed.

### CITATION LIST

### Patent Literature

PTL 1: JP 2017-218032 A

PTL 2: JP 2020-149487 A

### SUMMARY OF INVENTION

### Technical Problem

Still, it may not be noticed that the vulnerable person in the vehicle is in a dangerous state.

An object of the present disclosure is to provide a danger detection system and the like for avoiding a danger occurring in a vehicle.

### Solution to Problem

A danger detection system according to one aspect of the present disclosure includes: a determination means for determining whether an inside of a parked or stopped vehicle is in a dangerous state based on at least one of information of an environment on the inside of the vehicle and information of an environment on an outside of the vehicle; an in-vehicle person detection means for detecting a person in the vehicle from a video of the inside of the vehicle in a case where it is determined that the vehicle is in the dangerous state; and a control means for, in a case where the person is detected, performing at least one of notification to the outside of the vehicle, unlocking of a door of the vehicle by an operation of an authorized person with respect to the vehicle, and opening of a window of the vehicle by the operation of the authorized person.

A danger detection system according to one aspect of the present disclosure includes: an in-vehicle person detection means for detecting a person in a parked or stopped vehicle; a determination means for determining whether an inside of the vehicle is in a dangerous state based on a state of a person in the vehicle; and a control means for, in a case where it is determined that the vehicle is in the dangerous state, performing at least one of notification to an outside of the vehicle, unlocking of a door of the vehicle by an operation of an authorized person for the vehicle, and opening of a window of the vehicle by the operation of the authorized person.

A danger detection method according to one aspect of the present disclosure includes: determining whether an inside of a parked or stopped vehicle is in a dangerous state based on at least one of information of an environment on the inside of the vehicle and information of an environment on an outside of the vehicle; detecting a person in the vehicle from a video of the inside of the vehicle in a case where it is determined that the vehicle is in the dangerous state; and performing, in a case where the person is detected, at least one of notification to the outside of the vehicle, unlocking of a door of the vehicle by an operation of an authorized person with respect to the vehicle, and opening of a window of the vehicle by the operation of the authorized person.

A danger detection method according to one aspect of the present disclosure includes: detecting a person in a parked or stopped vehicle; determining whether an inside of the vehicle is in a dangerous state based on a state of a person in the vehicle; and performing, in a case where it is determined that the vehicle is in the dangerous state, at least one of notification to an outside of the vehicle, unlocking of a door of the vehicle by an operation of an authorized person for the vehicle, and opening of a window of the vehicle by the operation of the authorized person.

A program according to one aspect of the present disclosure causes a computer to execute: determining whether an inside of a parked or stopped vehicle is in a dangerous state based on at least one of information of an environment on the inside of the vehicle and information of an environment on an outside of the vehicle; detecting a person in the vehicle from a video of the inside of the vehicle in a case where it is determined that the vehicle is in the dangerous state; and performing, in a case where the person is detected, at least one of notification to the outside of the vehicle, unlocking of a door of the vehicle by an operation of an authorized person with respect to the vehicle, and opening of a window of the vehicle by the operation of the authorized person.

A program according to one aspect of the present disclosure causes a computer to execute: detecting a person in a parked or stopped vehicle; determining whether an inside of the vehicle is in a dangerous state based on a state of a person in the vehicle; and performing, in a case where it is determined that the vehicle is in the dangerous state, at least one of notification to an outside of the vehicle, unlocking of a door of the vehicle by an operation of an authorized person for the vehicle, and opening of a window of the vehicle by the operation of the authorized person.

The program may be stored in a non-transitory computer-readable recording medium.

### Advantageous Effects of Invention

According to the present disclosure, it is possible to avoid danger occurring in a vehicle.

### BRIEF DESCRIPTION OF DRAWINGS

FIG. 1 is a block diagram illustrating a configuration example of a danger detection system according to a first example embodiment.

FIG. 2 is an explanatory diagram illustrating a flow of processing of detecting a person after determining whether the inside of the vehicle is in a dangerous state.

FIG. 3 is a flowchart illustrating a first operation example of the danger detection system according to the first example embodiment.

FIG. 4 is an explanatory diagram illustrating a flow of processing of determining whether the inside of the vehicle is in a dangerous state after a person is detected.

FIG. 5 is a flowchart illustrating a second operation example of the danger detection system according to the first example embodiment.

FIG. 6 is an explanatory diagram illustrating an example of connection between the danger detection system and another device.

FIG. 7 is a block diagram illustrating a configuration example of a danger detection system according to a second example embodiment.

FIG. 8 is an explanatory diagram illustrating a lighting example of an illumination device.

FIG. 9 is an explanatory diagram illustrating a notification screen example indicating that the vehicle is in a dangerous state.

FIG. 10 is an explanatory diagram illustrating a screen example of face authentication.

FIG. 11 is a flowchart illustrating a first operation example of the danger detection system according to the second example embodiment.

FIG. 12 is a flowchart illustrating a second operation example of the danger detection system according to the second example embodiment.

FIG. 13 is an explanatory diagram illustrating a hardware configuration example of a computer.

### EXAMPLE EMBODIMENT

Hereinafter, example embodiments of a danger detection system, a danger detection method, a program, and a non-transitory recording medium recording the program according to the present disclosure will be described in detail with reference to the drawings. The present example embodiment does not limit the disclosed technology.

### First Example Embodiment

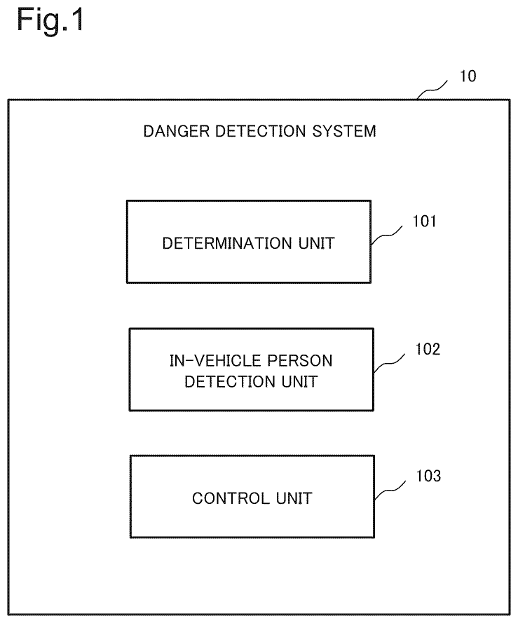

First, in a first example embodiment, a basic function of a danger detection system will be described. FIG. 1 is a block diagram illustrating a configuration example of the danger detection system according to the first example embodiment. A danger detection system 10 includes a determination unit 101, an in-vehicle person detection unit 102, and a control unit 103.

Next, two basic functional examples of the danger detection system 10 will be described.

First, a first basic function example will be described.

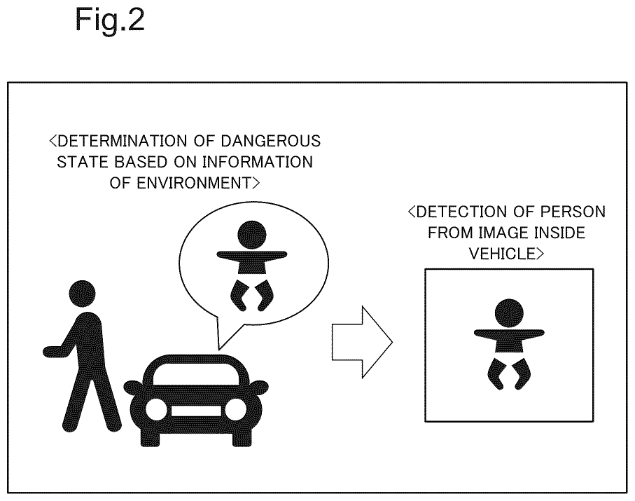

FIG. 2 is an explanatory diagram illustrating a flow of processing of detecting a person after determining whether the inside of the vehicle is in a dangerous state. In the first basic function example, the determination unit 101 determines whether the inside of the vehicle is in a dangerous state, and the in-vehicle person detection unit 102 detects a person in the vehicle from a video of the inside of the vehicle when the inside of the vehicle is in the dangerous state and when it is determined that the inside of the vehicle is in the dangerous state.

The determination unit 101 determines whether the inside of a vehicle is in a dangerous state based on information about the environment on the inside of a parked or stopped vehicle and/or information about the environment on the outside of the vehicle. Parking or stopping indicates a state in which the vehicle is temporarily or continuously stopped. The timing at which the determination unit 101 starts the determination as to whether the state is the dangerous state is not particularly limited. For example, this timing may be from the timing when the engine of the vehicle is stopped, or may be the timing when a predetermined time has elapsed since the engine of the vehicle has been stopped. The timing to start the determination may be a timing at which the driver has moved away from the vehicle, or may be a timing at which a predetermined time has elapsed since the driver has moved away from the vehicle.

Here, the information of the environment on the inside of the vehicle and the information of the environment on the outside of the vehicle are information of parameters that can affect safety, such as health and life of a person on the inside of the vehicle. For example, the information of the environment in the vehicle may be information indicating at least one of temperature, humidity, carbon monoxide concentration, oxygen concentration, and carbon dioxide concentration. For example, the information of the environment on the outside of the vehicle may be information indicating at least one of weather, climate, temperature, humidity, brightness, and a parking or stopping position. The parking or stopping position may be, for example, sunlit or shaded. For example, the information of the environment on the outside of the vehicle may be information regarding surrounding flooding due to a flood or the like. The information of the environment on the outside of the vehicle may be information of a fire in a surrounding building or the like.

In describing a specific determination method, a temperature is taken as an example of environment information. As the temperature, either the temperature on the inside of the vehicle or the temperature on the outside of the vehicle may be used. For example, in a case where the inside of the vehicle is too hot, the determination unit 101 determines that the inside of the vehicle is in a dangerous state. More specifically, the determination unit 101 may determine whether the inside of the vehicle is in a dangerous state based on whether the temperature on the inside of the vehicle is equal to or higher than a threshold. The determination unit 101 determines that the inside of the vehicle is in a dangerous state when the temperature on the inside of the vehicle is equal to or higher than the threshold, and determines that the inside of the vehicle is not in a dangerous state when the temperature on the inside of the vehicle is not equal to or higher than the threshold.

Alternatively, for example, in a case where the inside of the vehicle is too cold, the determination unit 101 determines that the inside of the vehicle is in a dangerous state. More specifically, the determination unit 101 may determine whether the inside of the vehicle is in a dangerous state based on whether the temperature on the inside of the vehicle is equal to or lower than a threshold. The determination unit 101 determines that the inside of the vehicle is in a dangerous state when the temperature on the inside of the vehicle is equal to or lower than a threshold, and determines that the inside of the vehicle is not in a dangerous state when the temperature on the inside of the vehicle is higher than a threshold.

In a case where the information of the environment in the vehicle is the humidity, the carbon monoxide concentration, the oxygen concentration, or the carbon dioxide concentration, similarly to the example of the temperature, the determination unit 101 may determine whether the vehicle is in a dangerous state by using comparison between the information of the environment in the vehicle and a threshold or the like, and thus detailed description thereof will be omitted.

In a case where the information of the environment on the outside of the vehicle is weather, climate, temperature, and humidity, similarly to the information of the environment on the outside of the vehicle, the determination unit 101 may determine whether the vehicle is in a dangerous state by using comparison between the information of the environment on the outside of the vehicle and a threshold, and thus, detailed description is omitted.

A position where the vehicle is parked or stopped is taken as an example of the information of the environment on the outside of the vehicle. The determination unit 101 may determine whether the inside of the vehicle is in a dangerous state depending on whether the position where the vehicle is parked or stopped is shaded or sunlit based on the information of the environment on the outside of the vehicle. For example, the determination unit 101 may determine that the inside of the vehicle is in a dangerous state in a case where the vehicle is parked or stopped in the sun after a lapse of a predetermined time after the vehicle is parked or stopped.

In a case where the information of the environment on the outside of the vehicle is information regarding surrounding flooding, the determination unit 101 may determine whether the inside of the vehicle is in a dangerous state based on the depth of the flooding, the distance from the location of the flooding to the vehicle, and the like. Specifically, for example, the determination unit 101 determines that the deeper the depth of flooding is, the more dangerous the state is. Alternatively, for example, the determination unit 101 determines that the shorter the distance from the flooded position to the vehicle, the more dangerous the state.

In a case where the information of the environment on the outside of the vehicle is information of a fire in a surrounding building or the like, the determination unit 101 may determine whether the inside of the vehicle is in a dangerous state based on the magnitude of the fire and the distance from the place where the fire has occurred to the vehicle.

Specifically, for example, the determination unit 101 determines that the larger the magnitude of the fire, the more dangerous the state is. Alternatively, for example, the determination unit 101 determines that the shorter the distance from the place where the fire has occurred to the vehicle, the more dangerous the state is.

The determination unit 101 may determine whether the inside of the vehicle is in a dangerous state based on a difference between the information of the environment on the inside of the vehicle and the information of the environment on the outside of the vehicle. For example, in a case where the temperature difference between the inside of the vehicle and the outside of the vehicle is too large on a cold day in winter, the inside of the vehicle may be dangerous.

In a case where it is determined that the vehicle is in a dangerous state, the in-vehicle person detection unit 102 detects a person in the vehicle from a video of the inside the vehicle. The video is one image or a plurality of time-series images. In a case where it is determined that the vehicle is in a dangerous state, the in-vehicle person detection unit 102 detects a person in the vehicle from the video of the inside the vehicle captured by the imaging device. As a method of detecting a person from a video, an existing technology may be used.

In a case where a person is detected in the vehicle, the control unit 103 performs at least one of notification to the outside of the vehicle, unlocking of a door of the vehicle, and opening of a window of the vehicle.

There are various methods for notification to the outside of the vehicle.

For example, the control unit 103 may control the device of the vehicle as a notification to the outside of the vehicle. Specifically, for example, the control unit 103 operates the wiper of the vehicle as a notification to the outside of the vehicle. For example, the control unit 103 turns on or blinks an illumination device of the vehicle as a notification to the outside of the vehicle. The control unit 103 sounds a horn of the vehicle.

The control unit 103 performs control to turn on or blink the illumination device in the parking lot.

For example, the control unit 103 may notify another terminal device as a notification to the outside of the vehicle. The other terminal device may be, for example, a terminal device of a driver or a terminal device of a vehicle owner. The other terminal device may be a terminal device of an administrator of a parking lot where the vehicle is parked or stopped. When the parking lot is a parking lot of the facility, the administrator of the parking lot is the administrator of the facility. For example, in a case where the facility is a store, the terminal device may be a terminal device of a store clerk, a device for registering or paying a product, a signage installed in the store, or the like. As a result, a person on the outside of the vehicle can easily notice the abnormality of the vehicle.

The other terminal device may be a device installed in a parking lot. The device installed in the parking lot may be a signage that guides the parking lot. In the case of a pay parking lot, the device installed in the parking lot may be a machine that pays a parking fee. The other terminal device may be a terminal device that manages a video when the vehicle travels. The terminal device may be a terminal device of a company that manages an imaging device that captures a video, or a terminal device of a company that manages a video when a vehicle travels. For example, the company may be an insurance company or the like of a vehicle, or may be a security company. Another terminal device may be a terminal device of the police officer. The another terminal device may be a terminal device provided in another vehicle that can communicate with the vehicle determined to be in a dangerous state. In this case, the other vehicle is a vehicle that can communicate with a vehicle determined to be in a dangerous state. For example, the other terminal device is a terminal device of a vehicle traveling in the vicinity of a vehicle determined to be in a dangerous state, or a terminal device of a vehicle stopping in the vicinity. A communication means between the vehicle determined to be in a dangerous state and another vehicle is not particularly limited, and may be a carrier line, wireless communication such as Wi-fi (registered product), or near field wireless communication such as Bluetooth (registered trademark).

The method of notifying the outside of the vehicle may be used in combination.

For example, the door of the vehicle may be unlocked by an operation of an authorized person with respect to the vehicle. The authorized person is, for example, a predetermined person such as a driver of a vehicle, a vehicle owner, a police officer, or a administrator of a parking lot. The opening of the vehicle window may be performed by an operation of an authorized person with respect to the vehicle. For example, the police officer may have a master key that can unlock the door or open the window of the vehicle registered in advance. Then, the control unit 103 unlocks the door or opens the window by the operation of the police officer. Examples of the operation by an authorized person include biometric authentication. An example of biometric authentication will be described in detail in the second example embodiment.

The determination method by the determination unit 101 and the control method by the control unit 103 may be combined. A determination method of determining whether the inside of the vehicle is in a dangerous state based on a difference between the information of the environment on the inside of the vehicle and the information of the environment on the outside of the vehicle, and a notification method of opening a window may be combined.

For example, in winter season, there is a case where the driver stops the vehicle on the road while turning on the heater due to snowfall. In such a case, carbon monoxide poisoning may occur in the vehicle due to snowfall. Therefore, the determination unit 101 may determine whether the inside of the vehicle is in a dangerous state based on whether a difference (large temperature difference) between the information of the environment on the inside of the vehicle and the information of the environment on the outside of the vehicle is equal to or larger than a threshold, and an elapsed time after the difference becomes equal to or larger than the threshold is equal to or longer than a predetermined time. Taking the temperature as an example, in a case where the temperature on the inside of the vehicle is high and the temperature on the outside of the vehicle is low, the determination unit 101 determines that the inside of the vehicle is in a dangerous state if the difference between the temperature on the inside of the vehicle and the temperature on the outside of the vehicle is equal to or greater than the threshold and the elapsed time from when the difference becomes equal to or greater than the threshold is equal to or greater than a predetermined time. Then, in a case where a person in the vehicle is detected, the control unit 103 opens the window. This makes it possible to suppress the occurrence of carbon monoxide poisoning.

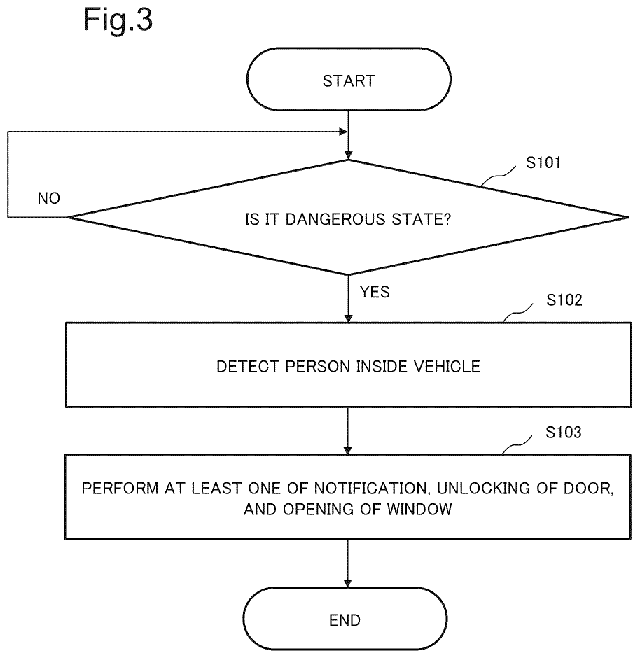

FIG. 3 is a flowchart illustrating a first operation example of the danger detection system 10 according to the first example embodiment. First, the determination unit 101 determines whether the inside of a vehicle is in a dangerous state based on information about the environment on the inside of a parked or stopped vehicle and/or information about the environment on the outside of the vehicle (step S101). In a case where it is determined that the user is not in a dangerous state (step S101: No), the determination unit 101 returns to step S101. This makes it possible to monitor whether the inside of the vehicle is in a dangerous state.

Next, in a case where it is determined that the vehicle is in a dangerous state (step S101: Yes), the in-vehicle person detection unit 102 detects a person in the vehicle from the video of the inside of the vehicle (step S102). In a case where a person in the vehicle is detected, the control unit 103 performs at least one of notification, door unlocking, and window opening (step S103).

Step S101 may be repeated until the driver returns or until the vehicle departs, for example.

As described above, in the first example embodiment, the danger detection system 10 determines whether the inside of the vehicle is in a dangerous state, detects a person from a video in a case where the inside of the vehicle is in a dangerous state, and performs notification, unlocking of a key, and opening of a window in a case where the person is detected. As a result, it is possible to notify that a person is left in a dangerous state in the vehicle or to take an initial action in an emergency such as opening a window or unlocking a key before another person notices a person in the vehicle in a dangerous state. This makes it possible to avoid danger.

Although the example in which the in-vehicle person detection unit 102 uses the video in the detection of the person has been described, the person in the vehicle may be detected using information other than the video. The in-vehicle person detection unit 202 may detect a person in the vehicle based on, for example, information acquired from a weight sensor, an acceleration sensor, or an infrared sensor installed in the vehicle. Alternatively, the in-vehicle person detection unit 102 may detect a person in the vehicle by using both the imaging device and these sensors.

Next, a second basic function example of the danger detection system 10 will be described.

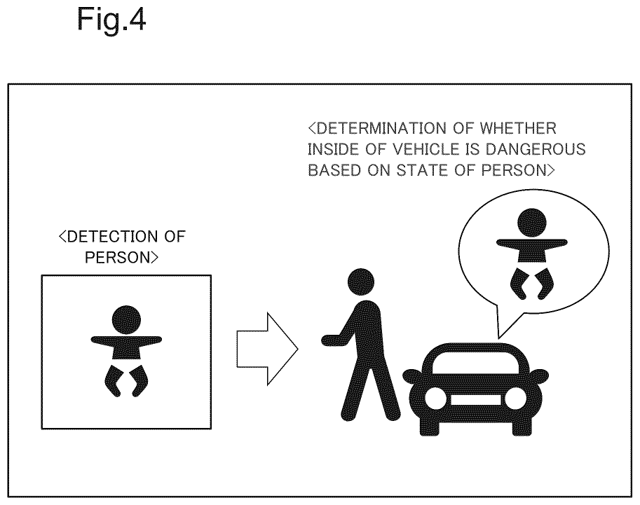

FIG. 4 is an explanatory diagram illustrating a flow of processing of determining whether the inside of the vehicle is in a dangerous state after a person is detected. In the first basic function example, the determination unit 101 determines whether the inside of the vehicle is in a dangerous state, and the in-vehicle person detection unit 102 detects a person in the vehicle from a video of the inside of the vehicle when the inside of the vehicle is in the dangerous state and when it is determined that the inside of the vehicle is in the dangerous state.

First, the in-vehicle person detection unit 102 detects a person in the vehicle. As a method of detecting a person in the vehicle, the in-vehicle person detection unit 102 may detect a person in the vehicle from a video of the inside of the vehicle captured by the imaging device. The timing at which the in-vehicle person detection unit 102 starts detecting a person in the vehicle is not particularly limited. For example, this timing may be from the timing when the engine of the vehicle is stopped, or may be the timing when a predetermined time has elapsed since the engine of the vehicle has been stopped. The timing to start the determination may be a timing at which the driver has moved away from the vehicle, or may be a timing at which a predetermined time has elapsed since the driver has moved away from the vehicle. As described in the first basic function example, the in-vehicle person detection unit 102 may detect a person in the vehicle using information other than the video in the detection of the person.

Next, the determination unit 101 determines whether the inside of the vehicle is in a dangerous state based on the state of the person in the vehicle. The state of the person in the vehicle is represented by information such as a respiratory rate, a body temperature, and a heart rate of the person in the vehicle. For example, the body temperature or the like may be a surface body temperature or the like of a person obtained by the imaging device. The heart rate and the respiratory rate may be acquired from a wearable device or the like worn by the person using near field wireless communication or the like.

As a determination method, the determination unit 101 may determine that the inside of the vehicle is in a dangerous state if the body temperature of the person is high. More specifically, for example, the determination unit 101 may determine that the inside of the vehicle is in a dangerous state if the body temperature of the person is equal to or higher than a threshold. The threshold may be determined for each person, or may be determined according to attributes such as the age and gender of the person. For example, the determination unit 101 may determine that the inside of the vehicle is in a dangerous state if the body temperature of the person is low. More specifically, for example, the determination unit 101 may determine that the inside of the vehicle is in a dangerous state if the body temperature of the person is equal to or less than a threshold. Similarly, the determination unit 101 may determine that the inside of the vehicle is in a dangerous state in a case where the heart rate is too high or too low. As in the example of the body temperature, a specific determination method may be performed by comparing the heart rate of the person with the threshold. Similarly, the determination unit 101 may determine that the inside of the vehicle is in a dangerous state in a case where the respiratory rate is too high or too low. As a specific determination method, the respiratory rate of the person may be compared with the threshold as in the example of the body temperature.

In a case where a person is detected, the control unit 103 performs at least one of notification to the outside of the vehicle, unlocking of a door of the vehicle, and opening of a window of the vehicle. Since a specific example of the control unit 103 is similar to the first functional example, a detailed description thereof will be omitted.

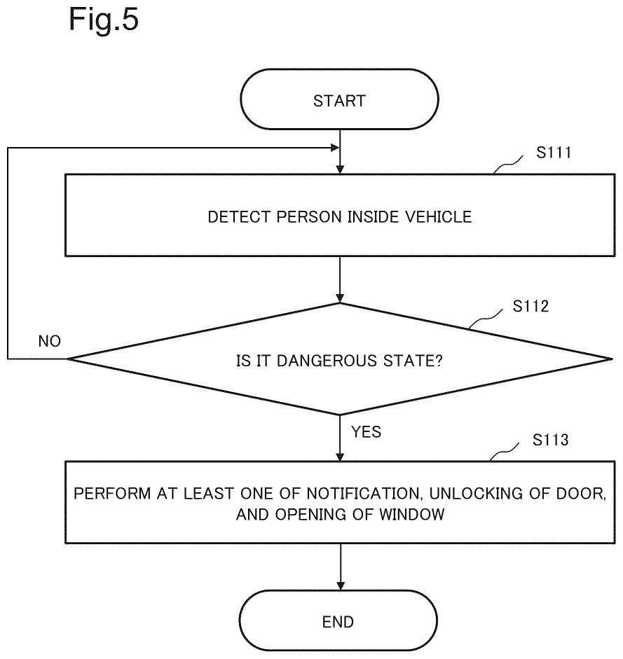

FIG. 5 is a flowchart illustrating a second operation example of the danger detection system 10 according to the first example embodiment. First, the in-vehicle person detection unit 102 detects a person in the vehicle (step S111). The determination unit 101 determines whether the inside of the vehicle is in a dangerous state based on the state of the person in the vehicle (step S112). In a case where the inside of the vehicle is not in a dangerous state (step S112: No), the control unit 103 returns to step S112. This makes it possible to monitor whether the inside of the vehicle is in a dangerous state.

In a case where the inside of the vehicle is in a dangerous state (step S112: Yes), the control unit 103 performs at least one of notification, door unlocking, and window opening (step S113).

Step S112 may be repeated until the driver returns or until the vehicle departs, for example.

As described above, in the first example embodiment, the danger detection system 10 detects a person in the vehicle, determines whether the inside of the vehicle is in a dangerous state based on the state of the person, and performs notification, unlocking of a key, and opening of a window in a case where the inside of the vehicle is in the dangerous state. As a result, it is possible to notify that a person is left in a dangerous state in the vehicle or to take an initial action in an emergency such as opening a window or unlocking a key before another person notices a person in the vehicle in a dangerous state. This makes it possible to avoid danger.

### Second Example Embodiment

Next, a second example embodiment will be described in detail with reference to the drawings. In the second example embodiment, specific notification, door unlocking, window opening, and the like will be described as examples. Hereinafter, description of content overlapping with the above description will be omitted to the extent that the description of the second example embodiment is not unclear.

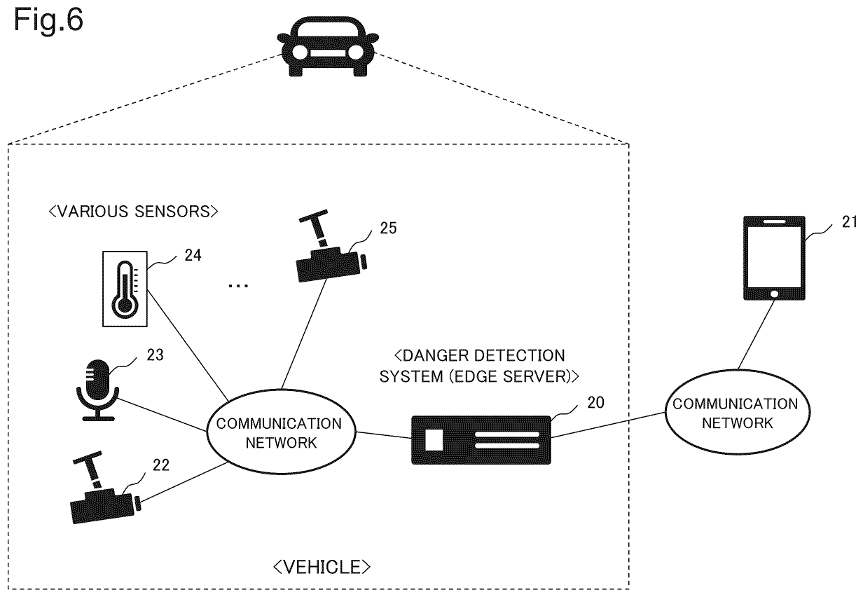

FIG. 6 is an explanatory diagram illustrating an example of connection between the danger detection system and another device. Here, an example in which a danger detection system 20 is achieved by an edge server or the like in the vehicle will be described. Therefore, it is assumed that the danger detection system 20 is installed in the vehicle.

For example, the danger detection system 20 is connected to various sensors such as an imaging device 22, a sound collecting device 23, a temperature sensor 24, and an imaging device 25 via a communication network in the vehicle. The communication network is not particularly limited as described later. The imaging device 22 images the inside of the vehicle. The imaging device 25 images the outside of the vehicle. The sound collecting device 23 collects sounds in the vehicle. The imaging device 22, the sound collecting device 23, and the imaging device 25 may be a single device. The temperature sensor 24 measures the temperature in the vehicle. The danger detection system 20 may be connected to other sensors such as a sensor that measures the humidity on the inside of the vehicle, a sensor that measures the carbon monoxide concentration on the inside of the vehicle, a sensor that measures the humidity on the outside of the vehicle, and a sensor that measures the temperature on the outside of the vehicle.

The danger detection system 20 may be connected to a wearable device or the like worn by a person in the vehicle via near field wireless communication or the like.

The danger detection system 20 is connected to an external terminal device 21 via a communication network or the like. The external terminal device 21 may be, for example, a terminal device 21 of an administrator in a parking lot, a terminal device 21 of a driver, or a terminal device 21 of a police officer. For example, in a case where a facility that has a parking lot is a store, the administrator in the parking lot may be a store clerk. The external terminal device 21 may be a terminal device 21 installed in a parking lot. For example, in the case of a pay parking lot, the terminal device 21 may be a machine or the like that pays a parking fee.

In the terminal device 21, for example, an application program capable of displaying the notification from the danger detection system 20 may be installed in advance.

The type of the terminal device 21 is not particularly limited to a personal computer (PC), a tablet-type device, a smartphone, various devices, and the like.

In FIG. 6, an example in which the danger detection system 20 is achieved by the edge server in the vehicle has been described, but the danger detection system 20 may be achieved by an edge server in the vehicle, a server on the outside of the vehicle, or the like.

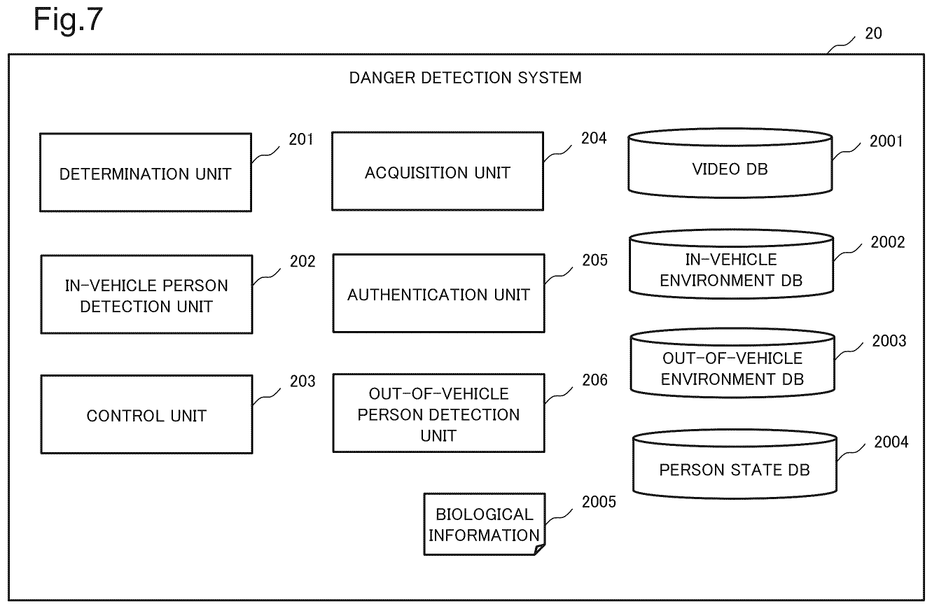

FIG. 7 is a block diagram illustrating a configuration example of the danger detection system 20 according to the second example embodiment. The danger detection system 20 includes a determination unit 201, an in-vehicle person detection unit 202, a control unit 203, an acquisition unit 204, an authentication unit 205, and an out-of-vehicle person detection unit 206.

The danger detection system 20 is obtained by adding the acquisition unit 204, the authentication unit 205, and the out-of-vehicle person detection unit 206 to the danger detection system 10 in the first example embodiment. The determination unit 201 may have the function of the determination unit 101 described in the first example embodiment as a basic function. The in-vehicle person detection unit 202 may have the function of the in-vehicle person detection unit 102 described in the first example embodiment as a basic function. The control unit 203 may have the function of the control unit 103 described in the first example embodiment as a basic function.

The danger detection system 20 may include a video DB 2001, an in-vehicle environment DB 2002, an out-of-vehicle environment DB 2003, a person state DB 2004, and biometric information 2005.

The video DB 2001 stores a video of the inside of the vehicle captured by the imaging device 22. For example, the acquisition unit 204 acquires a video from the imaging device 22 and stores the video in the video DB 2001. The video DB 2001 may store a video of the outside of the vehicle captured by the imaging device 25. The acquisition unit 204 acquires a video of the outside of the vehicle from the imaging device 25 and stores the video in the video DB 2001.

The in-vehicle environment DB 2002 stores information regarding the environment in the vehicle. The out-of-vehicle environment DB 2003 stores information regarding the environment on the inside of the vehicle. The person state DB 2004 stores information regarding a state of a person in the vehicle. The information regarding the state of the person is information such as a respiratory rate, a body temperature, and a heart rate of the person in the vehicle. The acquisition unit 204 acquires information from various sensors and the like, and stores the acquired information in any of the in-vehicle environment DB 2002, the out-of-vehicle environment DB 2003, and the person state DB 2004 according to the type of information.

The biometric information 2005 is, for example, data used for biometric authentication. The type of biometric authentication is not particularly limited, such as a fingerprint, an iris, and a face. In the second example embodiment, face authentication will be described as an example. The biometric information 2005 indicates a feature amount of a face registered in advance.

Next, the determination unit 201 and the in-vehicle person detection unit 202 will be described.

As in the first basic function example described in the first example embodiment, the determination unit 201 may determine whether the inside of the vehicle is in a dangerous state based on environment information, and the in-vehicle person detection unit 202 may detect a person in the vehicle. For example, the determination unit 201 determines whether the inside of the vehicle is in a dangerous state based on at least one of the information of the environment on the inside of the vehicle included in the in-vehicle environment DB 2002 and the information of the environment on the outside of the vehicle included in the out-of-vehicle environment DB 2003. A specific determination method is as described in the first example embodiment. In a case where it is determined that the vehicle is in a dangerous state, the in-vehicle person detection unit 202 detects a person in the vehicle from a video of the inside of the vehicle included in the video DB 2001.

As in a second basic function example described in the first example embodiment, after the in-vehicle person detection unit 202 detects a person, the determination unit 201 determines whether the inside of the vehicle is in a dangerous state based on the state of the person in the vehicle. For example, the in-vehicle person detection unit 202 detects a person in the vehicle from a video of the inside of the vehicle included in the video DB 2001. Then, for example, the determination unit 201 determines whether the person in the vehicle is in a dangerous state based on the information regarding the state of the person included in the person state DB 2004.

In the detection of the person, the in-vehicle person detection unit 202 may detect the person in the vehicle using information other than the video of the inside of the vehicle. The in-vehicle person detection unit 202 may detect a person in the vehicle based on, for example, information acquired from a weight sensor, an acceleration sensor, or an infrared sensor installed in the vehicle. Alternatively, the in-vehicle person detection unit 202 may detect a person in the vehicle by using the imaging device 22 and these sensors in combination.

Next, the control unit 203 will be described in detail. The control unit 203 performs at least one of notification to the outside of the vehicle, unlocking of a door of the vehicle, and opening of a window of the vehicle.

An example of the notification to the outside of the vehicle is as described in the first example embodiment. Here, an example of notifying the terminal device 21, an example of operating the wiper, and an example of turning on or blinking the illumination device installed in the parking lot will be described in detail.

First, a case of notifying the terminal device 21 will be described. An example of the terminal device 21 is as described above. Here, when notifying the terminal device 21, the control unit 203 may also notify the terminal device 21 of the video of the inside of the vehicle. As a result, the state in the vehicle can be visually confirmed. When notifying the terminal device 21, the control unit 203 may also notify the terminal device 21 of a video of the outside of the vehicle together. As a result, it is easy for another person who has received the notification from the driver, the administrator of the facility, or the like to specify the parking or stopping position of the target vehicle. The control unit 203 may notify the information of the environment such as the in-vehicle temperature of the vehicle together. The control unit 203 may notify of an elapsed time or the like from the time at which it is considered that the leaving has occurred. The time when the leaving is considered to have occurred is the time when the engine is turned off, the time when the door of the vehicle is last locked, and the like.

The control unit 203 may operate the wiper of the vehicle as a notification to the outside of the vehicle. As a result, a person on the outside of the vehicle can easily notice an abnormality in the vehicle by finding the vehicle in which the wiper is moving.

For example, operating the wiper is useful in a case where there is a person on the outside of the vehicle. Therefore, the out-of-vehicle person detection unit 206 detects whether there is a person in the vicinity of the vehicle. For example, the out-of-vehicle person detection unit 206 detects whether there is a person in the vicinity of the vehicle from the video captured by the imaging device 25 capable of capturing the outside of the vehicle. The imaging device 25 may be an imaging device that images the outside of the vehicle through the windshield of the vehicle, or may be an imaging device that images the rear of the vehicle. The vicinity here is not particularly limited as long as it is within a range that can be imaged by the imaging device 25. If a person appears in the video, the out-of-vehicle person detection unit 206 may detect that there is a person in the vicinity of the vehicle. Then, in a case where it is detected that there is a person in the vicinity of the vehicle, the control unit 203 may operate the wiper of the vehicle. The control unit 203 may combine the horn and the operation of the wiper as the notification to the outside of the vehicle. This makes it easier for a person on the outside of the vehicle to notice the abnormality of the vehicle.

For example, the control unit 203 turns on or blinks the illumination device installed in the parking lot so as to be able to identify the notification as the notification to the outside of the vehicle. As an example of turning on or blinking the illumination device so that the notification can be identified, the control unit 203 may turn on or blink the illumination device in a predetermined color. For example, the control unit 203 may turn on or blink in a color different from the color of other illumination devices. As an example of turning on or blinking the illumination device so that the notification can be identified, the control unit 203 may blink the illumination device in a pattern different from other illumination devices.

Specifically, for example, the control unit 203 instructs the terminal device 21 of the administrator of the parking lot to turn on or blink the illumination device installed in the parking lot. When receiving the instruction, the terminal device 21 turns on or blinks the illumination device. There may be a mechanism in which the control unit 203 can directly control turning-on and blinking of the illumination device for emergency.

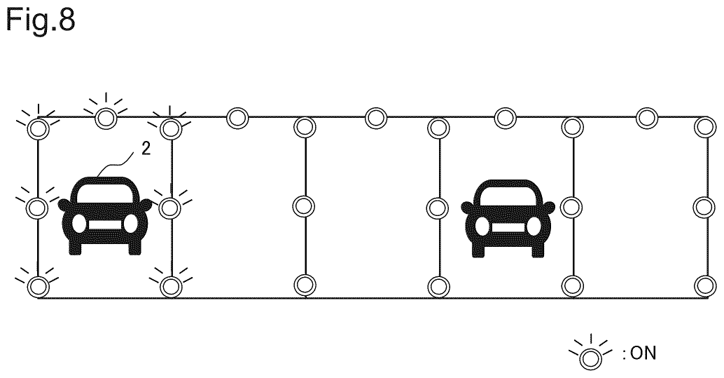

FIG. 8 is an explanatory diagram illustrating a lighting example of the illumination device. In FIG. 8, an illumination device is installed in each parking frame of the parking lot. The control unit 203 turns on an illumination device in which the vehicle is parked or stopped as a notification to the outside of the vehicle. This makes it easy for a person on the outside of the vehicle to notice an abnormality of the vehicle parked or stopped in the parking frame in which the illumination device is turned on.

Similarly to the example of operating the wiper, the out-of-vehicle person detection unit 206 detects whether there is a person in the vicinity of the vehicle. In a case where there is a person in the vicinity of the vehicle, the control unit 203 may turn on or blink an illumination device in which the vehicle is parked or stopped as a notification to the outside of the vehicle.

In this manner, in a case where the out-of-vehicle person detection unit 206 detects that there is a person in the vicinity of the vehicle, the control unit 203 may give some sort of notification.

Next, an example in which the control unit 203 unlocks the door of the vehicle and opens the window of the vehicle will be described. As described in the first example embodiment, the control unit 203 may unlock a door of the vehicle or open a window of the vehicle by an operation of an authorized person on the vehicle.

Here, an example will be described in which when an authorized person performs the biometric authentication, the control unit 203 performs either the unlocking of the door of the vehicle or the opening of the window of the vehicle in a case where the authentication is performed.

The acquisition unit 204 acquires information regarding a face of a person on the outside of the vehicle. The information of the face of the authorized person may be a face image or a feature amount of the face.

Then, the authentication unit 205 compares the biometric information 2005 with the information regarding the face, thereby authenticating whether the person is an authorized person. In a case where the authentication is performed, the control unit 203 either unlocks the door of the vehicle or opens the window of the vehicle.

Here, notification and authentication examples will be described in more detail with reference to the drawings. For example, the control unit 203 notifies the terminal device 21 of an authorized person that the vehicle is in a dangerous state and instructs the terminal device to perform face authentication. For example, the control unit 203 may display the current image of the person in the vehicle on the terminal device 21.

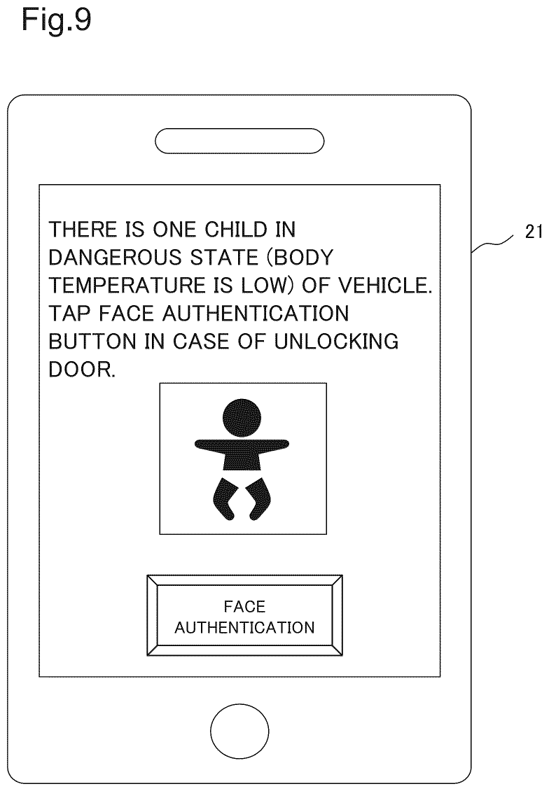

FIG. 9 is an explanatory diagram illustrating a notification screen example indicating that the vehicle is in a dangerous state. In FIG. 9, the screen of the terminal device 21 displays that the vehicle is in a dangerous state. A current image of a person in the vehicle is displayed on the screen of the terminal device 21.

The screen of the terminal device 21 includes a face authentication button. For example, when the face authentication button is tapped, the control unit 203 causes the terminal device 21 to perform face authentication.

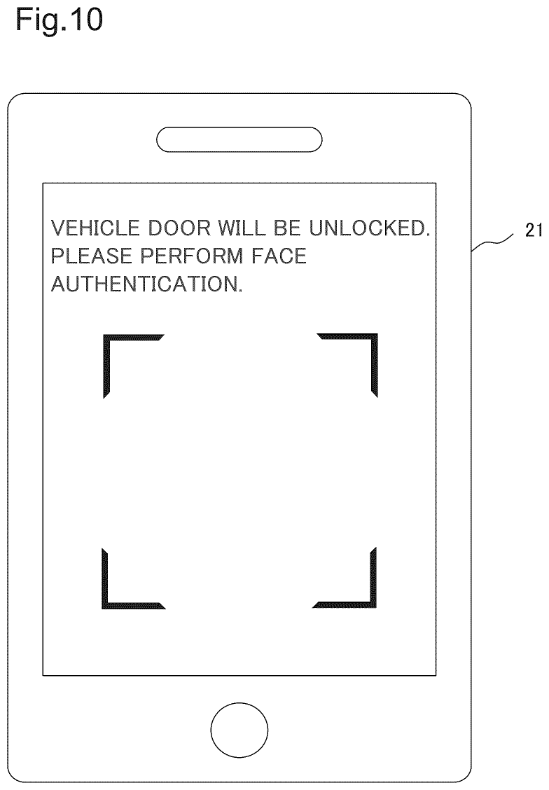

FIG. 10 is an explanatory diagram illustrating a screen example of face authentication. For example, in FIG. 10, the screen of the terminal device 21 is a screen for performing face authentication. For example, the imaging device 22 of the terminal device 21 captures an image of the face shown in the frame of the screen. The terminal device 21 transmits the feature amount of the face extracted from the photographed face image to the danger detection system 20.

The acquisition unit 204 acquires information regarding the face of the person from the terminal device 21. Then, the authentication unit 205 compares the biometric information 2005 with the feature amount of the face to authenticate whether the person is an authorized person.

Next, in a case where the authorized person is authenticated, control unit 203 performs at least one of unlocking the door and opening the window.

The biometric authentication may be performed by the terminal device 21.

The control unit 203 may control air conditioning in a dangerous state. For example, the control unit 203 may control the air conditioning to lower the temperature in the vehicle in a case where it is too hot. For example, the control unit 203 may control the air conditioning to increase the temperature in the vehicle in a case where the temperature is too low. In a case where the humidity is too high, the control unit 203 may turn on the air conditioning if the air conditioning is turned off.

### Control According to Security Level

For example, the vehicle may be provided with a security level in advance. The security level indicates a degree of security. The higher the security level, the more restricted the controllable operation, and the lower the security level, the less restricted the controllable operation. Control that can be performed by the control unit 203 may be determined in advance for each security level. In a case where the inside of the vehicle is in a dangerous state, the control unit 203 lowers the security level of the vehicle and performs control according to the security level. For example, the control unit 203 may perform control such that the security level of the vehicle becomes lower as the state in the vehicle becomes dangerous. A method of expressing the security level is not particularly limited. For example, the control unit 203 performs at least one of notification to the outside of the vehicle, unlocking of the door, and opening of the window according to the security level.

For example, the security level may be increased in a case where the inside of the vehicle is not in a dangerous state, that is, in a normal state, and the control unit 203 may decrease the security level in a case where it is determined that the inside of the vehicle is in a dangerous state.

A case where the security level has three stages of high, medium, and low will be described as an example. The control unit 203 may set the security level to be high in a case where the inside of the vehicle is not in a dangerous state, and may set the security level to medium or low in a case where the inside of the vehicle is in a dangerous state.

Here, an example of control for each security level will be described. When the security level is high, the driver cannot open the window or unlock the door except for the key of the vehicle. For example, if the security level is middle, the control unit 203 opens the window or unlocks the door by an operation of an authorized person.

For example, when the security level is low, the control unit 203 automatically opens the window or unlocks the door. As described above, the control unit 203 may perform control such that the lower the security level, the more it is possible to accept an operation from a person other than the vehicle owner.

Another example of the control for each security level will be described. When the security level is high, the driver cannot open the window or unlock the door except for the key of the vehicle. For example, in a case where the security level is medium, the control unit 203 causes the vehicle owner to open the window or unlock the door.

For example, when the security level is low, the control unit 203 causes a police officer to open a window or unlock a door.

As an example of determining whether the inside of the vehicle is in a dangerous state based on the body temperature of a person in the vehicle, the determination unit 201 determines that the inside of the vehicle is in a dangerous state when the body temperature of the person in the vehicle is 37.0 degrees or more. In a case where it is determined that the inside of the vehicle is in a dangerous state, the control unit 203 may set the security level to be middle if the body temperature of the person in the vehicle is 37.0 degrees, and set the security level to the low if the body temperature of the person in the vehicle is 37.5 degrees.

The control unit 203 may change the security level according to the elapsed time from the determination of the dangerous state. For example, the control unit 203 may lower the security level as the elapsed time is longer.

Examples of the security level, the setting of the security level in the state in the vehicle, and the control content are merely examples, and are not particularly limited.

### Flowchart

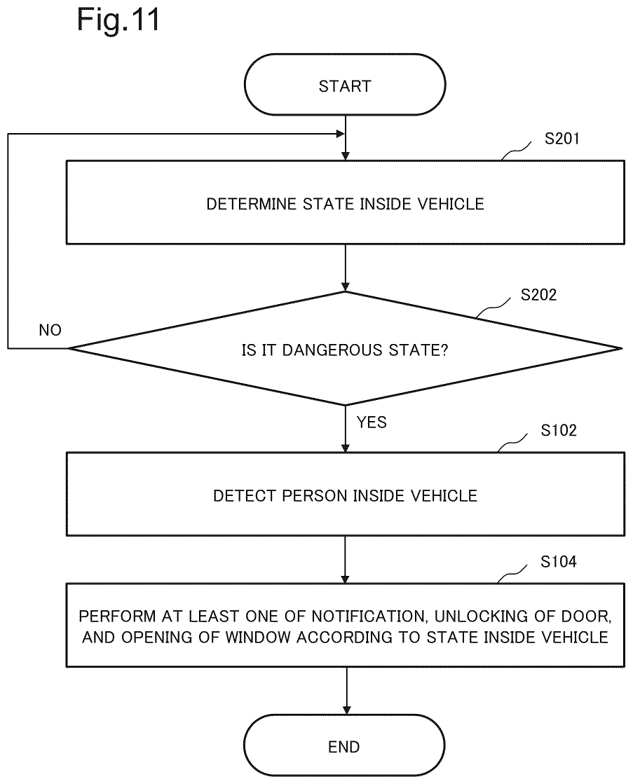

FIG. 11 is a flowchart illustrating a first operation example of the danger detection system 20 according to the second example embodiment. First, the determination unit 201 determines the state in a vehicle based on information about the environment on the inside of a parked or stopped vehicle and/or information about the environment on the outside of the vehicle (step S201). Then, the determination unit 201 determines whether the inside of the vehicle is in a dangerous state (step S202). In a case where it is determined that the user is not in a dangerous state (step S202: No), the determination unit 201 returns to step S201. This makes it possible to monitor whether the inside of the vehicle is in a dangerous state.

Next, in a case where it is determined that the vehicle is in a dangerous state (step S202: Yes), the in-vehicle person detection unit 202 detects a person in the vehicle from the video of the inside of the vehicle (step S203). In a case where a person in the vehicle is detected, the control unit 203 performs at least one of notification, door unlocking, and window opening according to the state in the vehicle (step S204). In step S204, the control unit 203 may lower the security level according to the state in the vehicle and perform processing according to the security level.

Steps S201 and S202 may be repeated, for example, until the driver returns or until the vehicle departs.

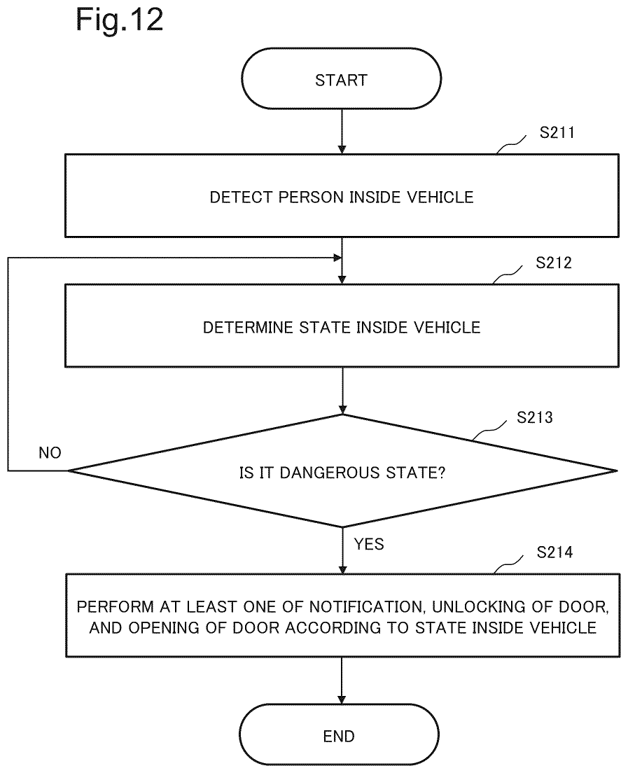

FIG. 12 is a flowchart illustrating a second operation example of the danger detection system 20 according to the second example embodiment. First, the detection unit detects a person in the vehicle (step S211). The determination unit 201 determines the state in the vehicle based on the state of the person in the vehicle (step S212).

The determination unit 201 determines whether the inside of the vehicle is in a dangerous state (step S213). In a case where the inside of the vehicle is not in a dangerous state (step S213: No), the control unit 203 returns to step S212. This makes it possible to monitor whether the inside of the vehicle is in a dangerous state.

In a case where the inside of the vehicle is in a dangerous state (step S213: Yes), the control unit 203 performs at least one of notification, door unlocking, and window opening according to the state on the inside of the vehicle (step S214). In step S214, the control unit 203 may lower the security level according to the state in the vehicle and perform processing according to the security level.

Steps S212 and S213 may be repeated, for example, until the driver returns or until the vehicle departs.

As described above, in the second example embodiment, the operation of the authorized person may be the operation of biometric authentication of the person on the outside of the vehicle registered in advance. This makes it possible to avoid danger while maintaining security.

The danger detection system 20 may operate the wiper of the vehicle as a notification to the outside of the vehicle. However, the danger detection system 20 may operate the wiper of the vehicle in a case where there is a person in the vicinity of the vehicle. As a result, a person on the outside of the vehicle can easily recognize an abnormality in the vehicle.

The danger detection system 20 controls the illumination device installed in the parking lot where the vehicle is parked or stopped so that the notification can be identified as the notification to the outside of the vehicle. As a result, a person on the outside of the vehicle can easily notice an abnormality in the vehicle.

The danger detection system 20 notifies the terminal device 21 of a facility that manages a parking lot where the vehicle is parked or stopped as a notification to the outside of the vehicle. As a result, the administrator of the facility who is a person on the outside of the vehicle can easily notice the abnormality of the vehicle. There is a high possibility that necessary arrangements or the like are made, and danger can be further avoided.

The danger detection system 20 notifies the terminal device 21 that manages a video when the vehicle travels as a notification to the outside of the vehicle. The terminal device 21 is a terminal device 21 of a company that manages the imaging device 25 or a terminal device of a company that manages a video when the vehicle travels. As a result, a person on the outside of the vehicle can easily notice the abnormality of the vehicle. There is a high possibility that necessary arrangements or the like are made, and danger can be further avoided.

The danger detection system 20 may notify a terminal device provided in another vehicle that can communicate with the vehicle as a notification to the outside of the vehicle. As a result, a person on the outside of the vehicle can easily notice the abnormality of the vehicle. For example, in a case where the danger detection system 20 performs notification using near field wireless communication as the communication means, a person who is closer to the vehicle easily notices the abnormality of the vehicle.

The description of each example embodiment is ended. The example embodiments may be used in combination as appropriate.

The example embodiments are not limited to the examples described above, and various modifications can be made. The configuration of the danger detection system 20 in each example embodiment is not particularly limited. For example, the danger detection system 20 may be achieved by one device such as one server. In a case where each functional unit of the danger detection system 20 is achieved by one device, for example, one device may be referred to as a danger detection device, an information processing device, or the like, and is not particularly limited. Alternatively, the danger detection system 20 in each example embodiment may be achieved by a different device for each function or data. For example, each functional unit may be configured by a plurality of servers and implemented as the danger detection system 20. For example, in the danger detection system 20, some functional units may be achieved by an edge server in the vehicle, and some functional units may be achieved by a server on the outside of the vehicle. For example, the danger detection system 20 may be achieved by a database server including each DB and a server including each functional unit. For example, in a case where a database server of an insurance company includes a video DB, and the danger detection system 20 transmits a captured video to the database server of the insurance company and uses the video in each functional unit, the acquisition unit 204 may acquire the video from the database server of the insurance company.

In each example embodiment, each piece of information and each DB may include part of the information described above. Each piece of information and each DB may include information other than the above-described information. Each piece of information or each DB may be divided into a plurality of DBs or a plurality of pieces of information in more detail. As described above, a method of achieving each piece of information and each DB is not particularly limited.

Each screen is an example, and is not particularly limited. In each screen, a button, a list, a checkbox, an information display field, an input field, and the like (not illustrated) may be added. The background color of the screen and the like may be changed.

The process of generating information or the like to be displayed on a display of the terminal device 21 may be performed by the control units 103 and 203. For example, this process may be performed by the terminal device 21.

### Hardware Configuration Example of Computer

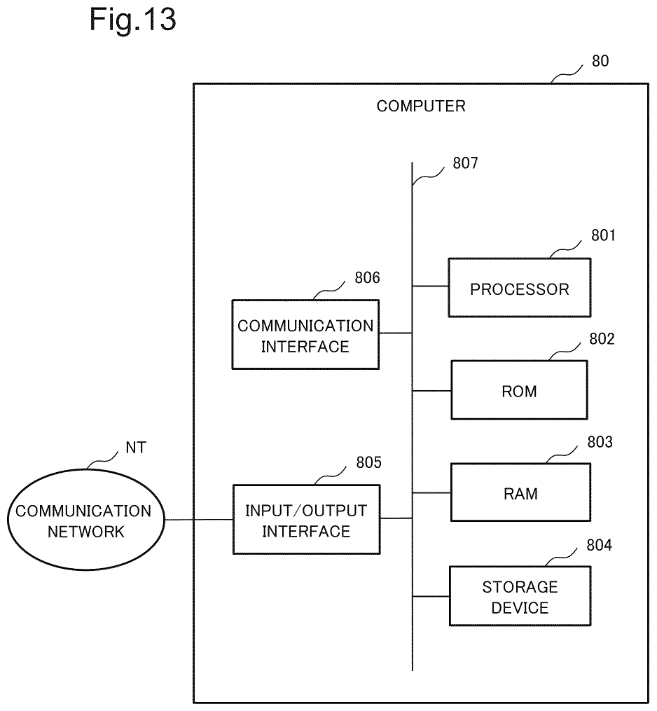

Next, a hardware configuration example in a case where each device in the danger detection systems 10 and 20 described in each example embodiment is achieved by a computer will be described. FIG. 13 is an explanatory diagram illustrating a hardware configuration example of a computer. For example, part or all of each device can be achieved by using any combination of a computer 80 and the program as illustrated in FIG. 13.

The computer 80 includes, for example, a processor 801, a read only memory (ROM) 802, a random access memory (RAM) 803, and a storage device 804. The computer 80 includes a communication interface 805 and an input/output interface 806. The components are connected via a bus 807 each other. The number of each component is not particularly limited, and each component is one or more.

The processor 801 controls the entire computer 80. Examples of the processor 801 include a central processing unit (CPU), a digital signal processor (DSP), and a graphics processing unit (GPU). The computer 80 includes the ROM 802, the RAM 803, the storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. The RAM 803 is used as a work area of the processor 801.

The processor 801 loads a program stored in the storage device 804, the ROM 802, or the like. The processor 801 executes each process coded in the program. The processor 801 may download various programs via the communication network NT. The processor 801 functions as part or all of the computer 80. The processor 801 may execute processes or instructions in the flowchart illustrated based on the program.

The communication interface 805 is connected to the communication network NT such as a local area network (LAN) or a wide area network (WAN) through a wireless or wired communication line. The communication network NT may include a plurality of communication networks NT. As a result, the computer 80 is connected to an external device or an external computer 80 via the communication network NT. The communication interface 805 manages an interface between the communication network NT and the inside of the computer 80. The communication interface 805 controls an input/output of data from the external device or the external computer 80.

The input/output interface 806 is connected to at least any one of an input device, an output device, and an input/output device. The connection method may be wireless or wired. Examples of the input device include a keyboard, a mouse, and a microphone. Examples of the output device include a display device, an illumination device, and a sound output device that outputs a sound. Examples of the input/output device include a touch panel display. The input device, the output device, the input/output device, and the like may be built in the computer 80 or may be externally attached.

The hardware configuration of the computer 80 is an example. The computer 80 may have some components illustrated in FIG. 13. The computer 80 may have components other than those illustrated in FIG. 13. For example, the computer 80 may include a drive device or the like. The processor 801 may read a program or data stored in a recording medium attached to a drive device or the like into the RAM 803.

Examples of the non-transitory tangible recording medium include an optical disk, a flexible disk, a magnetic optical disk, and a Universal Serial Bus (USB) memory. As described above, for example, the computer 80 may include an input device such as a keyboard and a mouse. The computer 80 may include an output device such as a display. The computer 80 may include an input device, an output device, and an input/output device.

The computer 80 may include various sensors (not illustrated). The type of the sensor is not particularly limited. The computer 80 may include an imaging device capable of capturing images and videos.

The description of the hardware configuration of each device is ended. There are various modifications in a method of achieving each device. For example, each device may be achieved by any combination of a computer and a program different for each component. A plurality of components included in each device may be achieved by any combination of one computer and a program.

Part or all of each component of each device may be achieved by an application specific circuit. Part or all of each component of each device may be achieved by a general-purpose circuit including a processor such as a field programmable gate array (FPGA). Part or all of each component of each device may be achieved by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

In a case where part or all of each component of each device is achieved by a plurality of computers, circuits, and the like, the plurality of computers, circuits, and the like may be disposed in a centralized manner or in a distributed manner.

The danger detection method described in each example embodiment is implemented by the danger detection system. For example, the danger detection method is implemented by a computer such as a server or a terminal device executing a program prepared in advance.

The program described in each example embodiment is recorded in a computer-readable recording medium such as an HDD, an SSD, a flexible disk, an optical disk, a magnetic optical disk, and a USB memory. The program is executed by being read from the recording medium by the computer. The program may be distributed via the communication network NT.

The function of each component of the danger detection system in each example embodiment described above may be implemented by dedicated hardware such as a computer. Alternatively, each component may be achieved by software. Alternatively, each component may be achieved by a combination of hardware and software.

While the present disclosure has been particularly shown and described with reference to each of example embodiments, the present disclosure is not limited to the above example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.

### Supplementary Note 1

A danger detection system including:
a determination unit for determining whether an inside of a parked or stopped vehicle is in a dangerous state based on at least one of information of an environment on the inside of the vehicle and information of an environment on an outside of the vehicle;
an in-vehicle person detection unit for detecting a person in the vehicle from a video of the inside of the vehicle in a case where it is determined that the vehicle is in the dangerous state; and
a control unit for, in a case where the person is detected, performing at least one of notification to the outside of the vehicle, unlocking of a door of the vehicle by an operation of an authorized person with respect to the vehicle, and opening of a window of the vehicle by the operation of the authorized person.

### Supplementary Note 2

The danger detection system according to Supplementary Note 1, in which
the operation of the authorized person is an operation of biometric authentication of a person on the outside of the vehicle registered in advance.

### Supplementary Note 3

The danger detection system according to Supplementary Note 1 or 2, in which
the control unit operates a wiper of the vehicle as the notification to the outside of the vehicle.

### Supplementary Note 4

The danger detection system according to Supplementary Note 3, including an out-of-vehicle person detection unit for detecting whether there is a person in a vicinity of the vehicle, wherein
the control unit operates the wiper of the vehicle in a case where it is detected that the person is present in the vicinity.

### Supplementary Note 5

The danger detection system according to Supplementary Note 1, in which
the control unit controls an illumination device installed in a parking lot where the vehicle is parked or stopped in such a way that the notification can be identified as the notification to the outside of the vehicle.

### Supplementary Note 6

The danger detection system according to any one of Supplementary Notes 1 to 5, in which
the control unit notifies a terminal device of a facility that manages a parking lot where the vehicle is parked or stopped as the notification to the outside of the vehicle.

### Supplementary Note 7

The danger detection system according to any one of Supplementary Notes 1 to 6, in which
the control unit notifies a terminal device that manages a video when the vehicle travels as the notification to the outside of the vehicle.

### (Supplementary Note 8

The danger detection system according to any one of Supplementary Notes 1 to 7, in which
the control unit notifies a terminal device provided in another vehicle communicable with the vehicle as the notification to the outside of the vehicle.

### Supplementary Note 9

The danger detection system according to any one of Supplementary Notes 1 to 8, in which
the control unit further controls air conditioning in the vehicle.

### Supplementary Note 10

The danger detection system according to any one of Supplementary Notes 1 to 9, in which
the control unit lowers a security level of the vehicle and performs control according to the security level in a case where the inside of the vehicle is in the dangerous state.

### Supplementary Note 11

The danger detection system according to Supplementary Note 10, in which
the control unit performs control in such a way that the security level becomes lower as a state in the vehicle becomes dangerous.

### Supplementary Note 12

The danger detection system according to Supplementary Note 10 or 11, in which
the control unit performs control in such a way that an operation from a person other than an owner of the vehicle can be received as the security level is lower.

### Supplementary Note 13

The danger detection system according to any one of Supplementary Notes 1 to 12, in which
information of the environment on the inside of the vehicle is at least one of a temperature, humidity, a concentration of carbon monoxide, a concentration of oxygen, and a concentration of carbon dioxide, and
information of the environment on the outside of the vehicle is at least one of a temperature, humidity, brightness, and a parking or stopping position.

### Supplementary Note 14

The danger detection system according to any one of Supplementary Notes 1 to 13, in which
the determination unit determines whether the inside of the vehicle is in a dangerous state based on whether a difference between information of the environment on the inside of the vehicle and information of the environment on the outside of the vehicle is equal to or greater than a threshold, and an elapsed time from when the difference becomes equal to or greater than the threshold is equal to or greater than a predetermined time, and
the control unit opens the window in a case where the inside of the vehicle is in a dangerous state.

### Supplementary Note 15

A danger detection system including:
an in-vehicle person detection unit for detecting a person in a parked or stopped vehicle;
a determination unit for determining whether an inside of the vehicle is in a dangerous state based on a state of a person in the vehicle; and
a control unit for, in a case where it is determined that the vehicle is in the dangerous state, performing at least one of notification to an outside of the vehicle, unlocking of a door of the vehicle by an operation of an authorized person for the vehicle, and opening of a window of the vehicle by the operation of the authorized person.

### Supplementary Note 16

The danger detection system according to Supplementary Note 15, in which
the state of the person in the vehicle is at least one of a respiratory rate, a body temperature, and a heart rate of the person in the vehicle.

### Supplementary Note 17

The danger detection system according to Supplementary Note 15 or 16, in which
the operation of the authorized person is an operation of biometric authentication of a person on the outside of the vehicle registered in advance.

### Supplementary Note 18

The danger detection system according to any one of Supplementary Notes 15 to 17, in which
the control unit operates a wiper of the vehicle as the notification to the outside of the vehicle.

### Supplementary Note 19

The danger detection system according to Supplementary Note 18, including:
an out-of-vehicle person detection unit for detecting whether there is a person in a vicinity of the vehicle, in which
the control unit operates the wiper of the vehicle in a case where it is detected that the person is present in the vicinity.

### Supplementary Note 20

The danger detection system according to any one of Supplementary Notes 15 to 19, in which
the control unit controls an illumination device installed in a parking lot where the vehicle is parked or stopped in such a way that the notification can be identified as the notification to the outside of the vehicle.

### Supplementary Note 21

The danger detection system according to any one of Supplementary Notes 15 to 20, in which
the control unit notifies a terminal device of a facility that manages a parking lot where the vehicle is parked or stopped as the notification to the outside of the vehicle.

### Supplementary Note 22

The danger detection system according to any one of Supplementary Notes 15 to 21, in which
the control unit notifies a terminal device that manages a video when the vehicle travels as the notification to the outside of the vehicle.

### Supplementary Note 23

The danger detection system according to any one of Supplementary Notes 15 to 22, in which
the control unit notifies a terminal device provided in another vehicle communicable with the vehicle as the notification to the outside of the vehicle.

### Supplementary Note 24

The danger detection system according to any one of Supplementary Notes 15 to 23, in which
the control unit further controls air conditioning in the vehicle.

### Supplementary Note 25

The danger detection system according to any one of Supplementary Notes 15 to 24, in which
the control unit lowers a security level of the vehicle and performs control according to the security level in a case where the inside of the vehicle is in the dangerous state.

### Supplementary Note 26

The danger detection system according to Supplementary Note 25, in which
the control unit performs control in such a way that the security level becomes lower as a state in the vehicle becomes dangerous.

### Supplementary Note 27

The danger detection system according to Supplementary Note 25 or 26, in which
the control unit performs control in such a way that an operation from a person other than an owner of the vehicle can be received as the security level is lower.

### Supplementary Note 28

A danger detection method including:
determining whether an inside of a parked or stopped vehicle is in a dangerous state based on at least one of information of an environment on the inside of the vehicle and information of an environment on an outside of the vehicle;
detecting a person in the vehicle from a video of the inside of the vehicle in a case where it is determined that the vehicle is in the dangerous state; and
performing, in a case where the person is detected, at least one of notification to the outside of the vehicle, unlocking of a door of the vehicle by an operation of an authorized person with respect to the vehicle, and opening of a window of the vehicle by the operation of the authorized person.

### Supplementary Note 29

A danger detection method including:
detecting a person in a parked or stopped vehicle;
determining whether an inside of the vehicle is in a dangerous state based on a state of a person in the vehicle; and
performing, in a case where it is determined that the vehicle is in the dangerous state, at least one of notification to an outside of the vehicle, unlocking of a door of the vehicle by an operation of an authorized person for the vehicle, and opening of a window of the vehicle by the operation of the authorized person.

### Supplementary Note 30

A non-transitory computer-readable recording medium that records a program for causing a computer to execute:
determining whether an inside of a parked or stopped vehicle is in a dangerous state based on at least one of information of an environment on the inside of the vehicle and information of an environment on an outside of the vehicle;
detecting a person in the vehicle from a video of the inside of the vehicle in a case where it is determined that the vehicle is in the dangerous state; and
performing, in a case where the person is detected, at least one of notification to the outside of the vehicle, unlocking of a door of the vehicle by an operation of an authorized person with respect to the vehicle, and opening of a window of the vehicle by the operation of the authorized person.

### Supplementary Note 31

A non-transitory computer-readable recording medium that records a program for causing a computer to execute:
detecting a person in a parked or stopped vehicle;
determining whether an inside of the vehicle is in a dangerous state based on a state of a person in the vehicle; and
performing, in a case where it is determined that the vehicle is in the dangerous state, at least one of notification to an outside of the vehicle, unlocking of a door of the vehicle by an operation of an authorized person for the vehicle, and opening of a window of the vehicle by the operation of the authorized person.

### Supplementary Note 32

A program for causing a computer to execute:
determining whether an inside of a parked or stopped vehicle is in a dangerous state based on at least one of information of an environment on the inside of the vehicle and information of an environment on an outside of the vehicle;
detecting a person in the vehicle from a video of the inside of the vehicle in a case where it is determined that the vehicle is in the dangerous state; and
performing, in a case where the person is detected, at least one of notification to the outside of the vehicle, unlocking of a door of the vehicle by an operation of an authorized person with respect to the vehicle, and opening of a window of the vehicle by the operation of the authorized person.

### Supplementary Note 33

A program for causing a computer to execute:
detecting a person in a parked or stopped vehicle;
determining whether an inside of the vehicle is in a dangerous state based on a state of a person in the vehicle; and
performing, in a case where it is determined that the vehicle is in the dangerous state, at least one of notification to an outside of the vehicle, unlocking of a door of the vehicle by an operation of an authorized person for the vehicle, and opening of a window of the vehicle by the operation of the authorized person.

### REFERENCE SIGNS LIST

10, 20 danger detection system
21 terminal device
22 imaging device
23 sound collecting device
24 temperature sensor
25 imaging device
80 computer
101, 201 determination unit
102, 202 in-vehicle person detection unit
103, 203 control unit
204 acquisition unit
205 authentication unit
206 out-of-vehicle person detection unit
801 processor
802 ROM
803 RAM
804 storage device
805 communication interface
806 input/output interface
807 bus
2001 video DB
2002 in-vehicle environment DB
2003 out-of-vehicle environment DB
2004 person state DB
2005 biometric information
NT communication network

What is claimed is:

1. A danger detection system comprising:
at least one memory storing instructions; and
at least one processor configured to execute the instructions to:
determine whether an inside of a parked or stopped vehicle is in a dangerous state based on at least one of information of an environment on the inside of the vehicle and information of an environment on an outside of the vehicle;
detect a person in the vehicle from a video of the inside of the vehicle, the video being determined that the vehicle is in the dangerous state; and
perform, based on a result of detection of the person in the vehicle, at least one of notification to the outside of the vehicle, unlocking of a door of the vehicle by an operation of an authorized person with respect to the vehicle, and opening of a window of the vehicle by the operation of the authorized person.

2. The danger detection system according to claim 1, wherein
the operation of the authorized person is an operation of biometric authentication of a person on the outside of the vehicle registered in advance.

3. The danger detection system according to claim 1, wherein the at least one processor is further configured to execute the instructions to:
operate a wiper of the vehicle as the notification to the outside of the vehicle.

4. The danger detection system according to claim 3, wherein the at least one processor is further configured to execute the instructions to:
detect whether there is a person in a vicinity of the vehicle; and
operate the wiper of the vehicle in a case where it is detected that the person is present in the vicinity.

5. The danger detection system according to claim 1, wherein the at least one processor is further configured to execute the instructions to:
control an illumination device installed in a parking lot where the vehicle is parked or stopped in such a way that the notification can be identified as the notification to the outside of the vehicle.

6. The danger detection system according to claim 1, wherein the at least one processor is further configured to execute the instructions to:
notify a terminal device of a facility that manages a parking lot where the vehicle is parked or stopped as the notification to the outside of the vehicle.

7. The danger detection system according to claim 1, wherein the at least one processor is further configured to execute the instructions to:
notify a terminal device that manages a video when the vehicle travels as the notification to the outside of the vehicle.

8. The danger detection system according to claim 1, wherein the at least one processor is further configured to execute the instructions to:
notify a terminal device provided in another vehicle communicable with the vehicle as the notification to the outside of the vehicle.

9. The danger detection system according to claim 1, wherein the at least one processor is further configured to execute the instructions to:
control air conditioning in the vehicle.

10. The danger detection system according to claim 1, wherein the at least one processor is further configured to execute the instructions to:
lower a security level of the vehicle and performs control according to the security level in a case where the inside of the vehicle is in the dangerous state.

11. The danger detection system according to claim 10, wherein the at least one processor is further configured to execute the instructions to:
perform control in such a way that the security level becomes lower as a state in the vehicle becomes dangerous.

12. The danger detection system according to claim 10, wherein the at least one processor is further configured to execute the instructions to:
perform control in such a way that an operation from a person other than an owner of the vehicle can be received as the security level is lower.

13. The danger detection system according to claim 1, wherein
information of the environment on the inside of the vehicle is at least one of a temperature, humidity, a concentration of carbon monoxide, a concentration of oxygen, and a concentration of carbon dioxide, and
information of the environment on the outside of the vehicle is at least one of information indicating at least one of a temperature, humidity, brightness, and a parking or stopping position, information of surrounding flooding, and information of fire.

14. The danger detection system according to claim 1, wherein the at least one processor is further configured to execute the instructions to:
determine whether the inside of the vehicle is in a dangerous state based on whether a difference between information of the environment on the inside of the vehicle and information of the environment on the outside of the vehicle is equal to or greater than a threshold, and an elapsed time from when the difference becomes equal to or greater than the threshold is equal to or greater than a predetermined time; and
open the window in a case where the inside of the vehicle is in a dangerous state.

15.-27. (canceled)

28. A danger detection method comprising:
determining whether an inside of a parked or stopped vehicle is in a dangerous state based on at least one of information of an environment on the inside of the vehicle and information of an environment on an outside of the vehicle;
detecting a person in the vehicle from a video of the inside of the vehicle in a the video being determined that the vehicle is in the dangerous state; and
performing, based on a result of detection of the person in the vehicle, at least one of notification to the outside of the vehicle, unlocking of a door of the vehicle by an operation of an authorized person with respect to the vehicle, and opening of a window of the vehicle by the operation of the authorized person.

29. (canceled)

30. A non-transitory computer-readable recording medium that records a program for causing a computer to execute:
determining whether an inside of a parked or stopped vehicle is in a dangerous state based on at least one of information of an environment on the inside of the vehicle and information of an environment on an outside of the vehicle;
detecting a person in the vehicle from a video of the inside of the vehicle, the video being determined that the vehicle is in the dangerous state; and
performing, based on a result of detection of the person in the vehicle, at least one of notification to the outside of the vehicle, unlocking of a door of the vehicle by an operation of an authorized person with respect to the vehicle, and opening of a window of the vehicle by the operation of the authorized person.

31. (canceled)
